(19) United States
(12) Patent Application Publication
(10) Pub. No.: US 2023/0136662 A1
(43) Pub. Date: May 4, 2023

(54) Parallax Asynchronous Spacewarp for Multiple Frame Extrapolation

(71) Applicant: Meta Platforms Technologies, LLC, Menlo Park, CA (US)

(72) Inventors: Todd Douglas Keeler, Magrath (CA); Steven Paul Lansel, Apopka, FL (US)

(21) Appl. No.: 18/047,924

(22) Filed: Oct. 19, 2022

Related U.S. Application Data
(60) Provisional application No. 63/272,508, filed on Oct. 27, 2021.

(51) Int. Cl. G06T 3/00; G06T 3/40; G06T 7/20; G06T 7/70

(52) U.S. Cl. CPC G06T 3/0093; G06T 3/40; G06T 7/20; G06T 7/70; G06T 2207/30201

(57) ABSTRACT

In one embodiment, a method includes obtaining a first frame rendered for a first head pose and a second frame rendered for a second head pose, generating first motion vectors based on a first comparison between the first frame and the second frame, determining a first positional displacement vector based on the first head pose and the second head pose, determining a second positional displacement vector based on the second head pose and a subsequent head pose, generating a positional extrapolation for the subsequent head pose by projecting the second positional displacement vector onto the first positional displacement vector, generating a scaling factor based on the positional extrapolation, updating the second frame based on the scaling factor and the first motion vectors, and rendering a subsequent frame for the subsequent head pose based on the updated second frame.

### PRIORITY

This application claims the benefit under 35 U.S.C. § 119(e) of U.S. Provisional Patent Application No. 63/272,508, filed 27 Oct. 2021, which is incorporated herein by reference.

### TECHNICAL FIELD

This disclosure generally relates to artificial-reality systems, and in particular, related to parallax asynchronous spacewarp for multiple frame extrapolation.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### SUMMARY OF PARTICULAR EMBODIMENTS

Particular embodiments described herein relate to systems and methods for reconstructing a scene for multiple consecutive frames due to multiple frame drops by parallax asynchronous spacewarp (PASW) rendering technology. The PASW is a rendering technique to compensate for multiple frame drops and reduce discomfort of a user when the user has a translational movement by rendering an image based on the user's head pose change during the translational movement. The PASW described herein is a method of rendering a 2D image based on scaled motion vectors along a direction of the user's translational movement and a series of the last rendered frames (e.g., last two frames) before the frame drops. The PASW may be performed for a static scene and/or a dynamic scene. For the dynamic scene, each of the motion vectors may be decomposed to a parallel component that is parallel to the translational movement and a perpendicular component that is perpendicular to the translational movement, wherein the PASW may be selectively performed to extrapolate the parallel component of the motion vectors.

In particular embodiments, a computing device may obtain a first frame with a first head pose and a second frame with a second head pose. The first frame and the second frame may be two consecutive frames of an XR content. The computing device may then generating first motion vectors based on a first comparison between the first frame and the second frame. The computing device may warp the first frame to have the second frame's orientation prior to determining the first motion vectors. The computing device may determine a first positional displacement vector based on the first head pose and the second head pose and a second positional displacement vector based on the second head pose and a subsequent head pose. The computing device may then generate a positional extrapolation for the subsequent head pose by projecting the second positional displacement vector onto the first positional displacement vector. The computing device may generate a scaling factor based on the positional extrapolation and then update the second frame based on the scaling factor and the first motion vectors. The computing device may then render a subsequent frame for the subsequent head pose based on the updated second frame. The computing device may warp the second frame to have the subsequent frame's orientation. The subsequent image frame being rendered after at least two consecutive frames after the second frame. Each of the first motion vectors may comprise at least one of an object motion vector and a parallax motion vector. Additionally or alternatively, the computing device may determine a head motion direction based on the first head pose and the second head pose. The computing device may decompose each of the first motion vectors into a parallel component alongside the head motion direction, and a perpendicular component orthogonal to the head motion direction. The computing device may generate a parallel scaling factor and a perpendicular scaling factor. The computing device may update the second frame based on the parallel scaling factor and the parallel component, and the perpendicular scaling factor and the perpendicular component. The computing device may then render the subsequent frame for the subsequent head pose based on the updated second frame. The parallel scaling factor may be a position-based scaling factor, or a time-based scaling factor. The perpendicular scaling factor may be zero, or a time-based scaling factor.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example artificial reality system.

FIG. 1B illustrates an example augmented reality system.

FIG. 2 illustrates an example relative screen space motion in an XR environment.

FIG. 3 illustrates an example method for determining positional extrapolation due to user's translational movement.

FIG. 4 illustrates an example parallax asynchronous spacewarp rendering process.

FIG. 5 illustrates an example method for parallax asynchronous spacewarp for multiple frame extrapolation.

FIG. 6 illustrates an example method for parallax asynchronous spacewarp for multiple frame extrapolation based on decomposed component scaling.

FIG. 7 illustrates an example computer system.

### DESCRIPTION OF EXAMPLE EMBODIMENTS

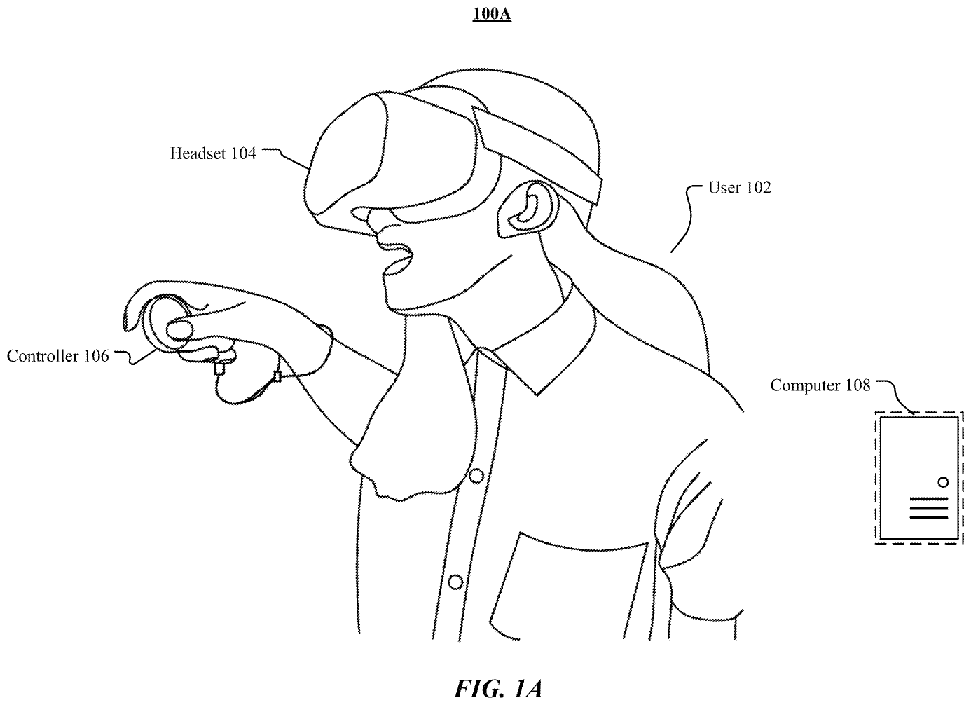

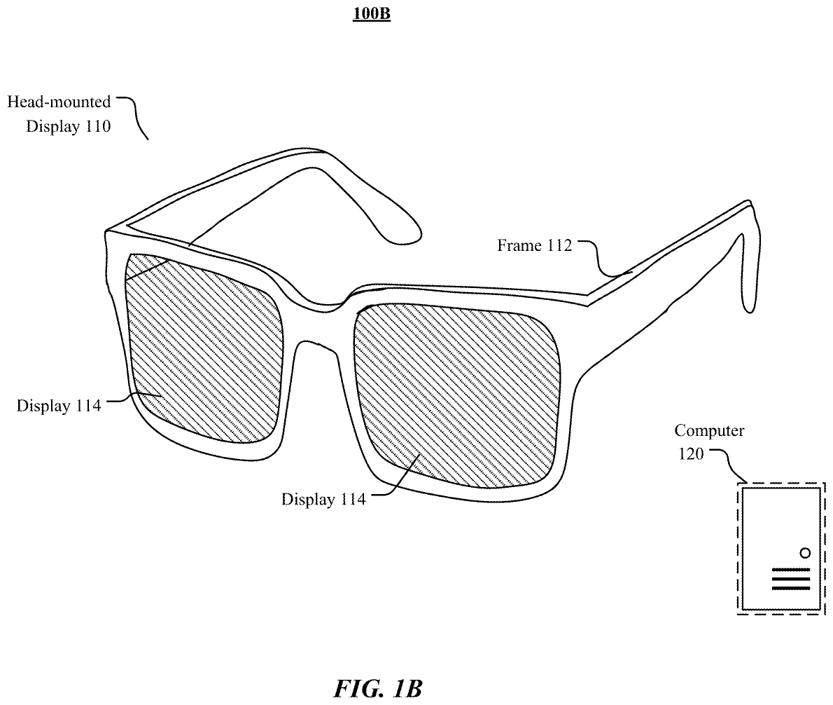

FIG. 1A illustrates an example artificial reality system 100A. In particular embodiments, the artificial reality system 100A may comprise a headset 104, a controller 106, and a computing device 108. A user 102 may wear the headset 104 that may display visual artificial reality content to the user 102. The headset 104 may include an audio device that may provide audio artificial reality content to the user 102. The headset 104 may include one or more cameras which can capture images and videos of environments. The headset 104 may include an eye tracking system to determine the vergence distance of the user 102. The headset 104 may include a microphone to capture voice input from the user 102. The headset 104 may be referred as a head-mounted display (HMD). The controller 106 may comprise a trackpad and one or more buttons. The controller 106 may receive inputs from the user 102 and relay the inputs to the computing device 108. The controller 106 may also provide haptic feedback to the user 102. The computing device 108 may be connected to the headset 104 and the controller 106 through cables or wireless connections. The computing device 108 may control the headset 104 and the controller 106 to provide the artificial reality content to and receive inputs from the user 102. The computing device 108 may be a standalone host computing device, an on-board computing device integrated with the headset 104, a mobile device, or any other hardware platform capable of providing artificial reality content to and receiving inputs from the user 102.

FIG. 1B illustrates an example augmented reality system 100B. The augmented reality system 100B may include a head-mounted display (HMD) 110 (e.g., glasses) comprising a frame 112, one or more displays 114, and a computing device 108. The displays 114 may be transparent or translucent allowing a user wearing the HMD 110 to look through the displays 114 to see the real world and displaying visual artificial reality content to the user at the same time. The HMD 110 may include an audio device that may provide audio artificial reality content to users. The HMD 110 may include one or more cameras which can capture images and videos of environments. The HMD 110 may include an eye tracking system to track the vergence movement of the user wearing the HMD 110. The HMD 110 may include a microphone to capture voice input from the user. The augmented reality system 100B may further include a controller comprising a trackpad and one or more buttons. The controller may receive inputs from users and relay the inputs to the computing device 108. The controller may also provide haptic feedback to users. The computing device 108 may be connected to the HMD 110 and the controller through cables or wireless connections. The computing device 108 may control the HMD 110 and the controller to provide the augmented reality content to and receive inputs from users. The computing device 108 may be a standalone host computing device, an on-board computing device integrated with the HMD 110, a mobile device, or any other hardware platform capable of providing artificial reality content to and receiving inputs from users.

Transmission of AR, VR, MR, and extended reality (XR) content over the internet or wireless networks is prone to interruption and packet loss. Especially for XR, it may be particularly problematic because the rendering device (e.g., HMD) may lose multiple consecutive frames without new XR content due to even short connection interruption. In some scenarios, when the users may continue to move their head while the XR content is not updated, it may break the scene of realism and may cause discomfort and/or dizziness for the users. As the trending demand for reducing HMD form factor and leveraging more power computation is a wearable device (e.g., hand hold controller, wearable Puck, etc.), PC, and/or Cloud, the transmission loss (e.g., multiple frames drop) may be an increasingly common problem.

Asynchronous timewarp (ATW) and Asynchronous spacewarp (ASW) may compensate for transmission loss to provide smooth user experience in XR. However, ATW may compensate transmission loss by correcting the user's vision due to head rotation, but may fail for user's head translation, and movement and/or animation of the virtual object in the XR content. ASW may attempt to compensate for the movement and/or animation of virtual object for 1 missing frame at a time, but fails for head translation, which is the larger contributor to discomfort. ASW may analyze a series of last rendered frames (e.g., 2 consecutive frames) to extract motion vectors for a dense set of points in the scene, which are used to reproject a new frame. The ASW may assume that the motion vectors may not change significantly over a single frame period at a general frame rate (e.g., 90 fps), and simply distort the 2D frame rendering to account for both the moving objects and head motion by warping the previously rendered frame. In ASW, the motion vectors are scaled based on the difference in the display times of the source frames relative to the difference in display times of the newly interpolated frame and the last rendered frame. Typically, applications using ASW may render at half of the display rate and generated motion vectors between the rendered frames are reduced by two to generate the other half of the frames to reach the display rate. When there are multiple frame drops, using ASW to generate multiple consecutive frames may result in the moving objects to continue across the virtual scene at a constant rate. However, the virtual objects that move across the scene due to head translation would similarly continue to move across the user's view at the same rate, which may cause discomfort and dizziness if the user's head does not continue translation in the same direction at the same speed.

ASW may use motion vectors generated from the preceding two frames to deduce the relative screen space motion. The derived motion vectors may be composed of three distinct types of motion. One type of motion may be rotational head motion, which may occur if the head is rotated between the two rendered frames. The rotational head motion be removed from the motion vectors by either subtracting, from each motion vector, a vector corresponding to the head rotation difference between the head poses for the rendered frames or calculating the motion vector not with the older rendered frame but a time warped reprojection of the older rendered frame that modified it to have the same head rotation. Another type of motion may be translational head motion, wherein static scene objects will move relative to their depth, which is also known as parallax. Another type of motion may be object motion, which may be the actual motion of objects in the 3D scene. ASW may correct for translational head motion and object motion based on an assumption that the head pose and the object motion may have a constant velocity. It may be reasonable to make such assumption when estimating a single frame considering the large mass of the user's head and fast display refresh rate. However, when considering multiple frames drops and extrapolating over larger time scales due to acceleration and decorrelation between the translational head motion and object motion, the assumption that the head pose and the object motion may have a constant velocity may not hold. It may be difficult to differentiate between the contributions of the translational head motion and the object motion without additional information, which is required to create motion vectors necessary to generate a new frame at a novel head pose for objects undergoing constant velocity. A computing device may use depth to accommodate for reprojection. When using depth to accommodate for reprojection, relative head poses may be used to compute the parallax change and no display time difference is needed; only object motion needs time information to be reprojected. Using depth to reproject previous frames is referred to as Positional TimeWarp (PTW). A combination of PTW and ASW may deliver better reprojection than ASW, especially for multiple frame reconstruction, where the parallax motion is accurately reprojected using head pose rather than display time difference. However, depth is not always available as it is expensive to compute and transmit.

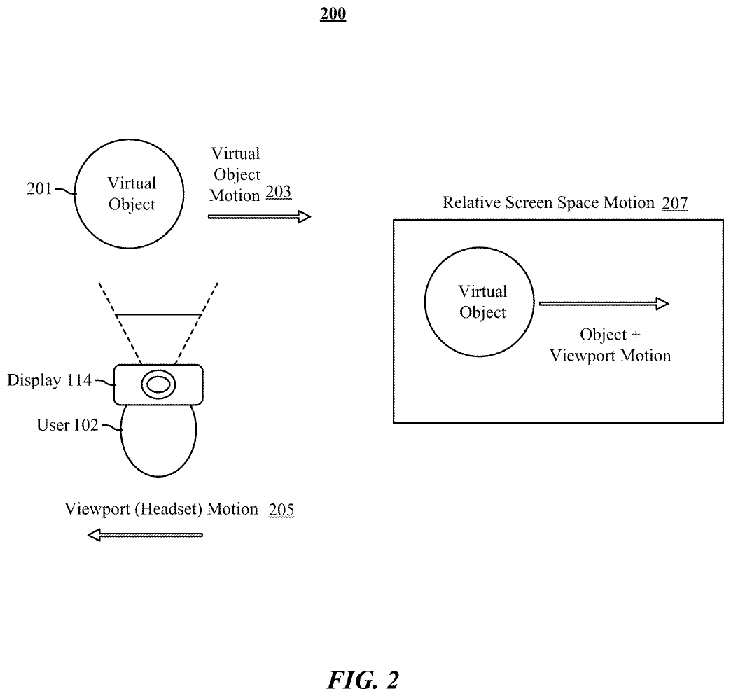

To address the above-mentioned technical difficulties, the computing device 108 may perform PASW by scaling the motion vectors based on head pose changes to generate new frames by morphing the latest rendered frame to reconstructs the scene for multiple consecutive frames and reduce discomfort of users in the translational movement. As described above, it is difficult to decorrelate the motion vector component caused by moving objects or head translation. FIG. 2 illustrates an example relative screen space motion in an XR environment. The relative screen space motion may comprise at least one of an object motion and a viewpoint motion. For example, the user 102 wearing the display 104 may see a virtual object 201 moving along a direction to the right from the user 102's viewpoint. The virtual object 201 along a direction to the right may be caused by a virtual object motion 203 to the right, a viewpoint (e.g., HMD position) motion 205 to the left, or a combination of both. From the user 102's viewpoint, the relative screen space motion may be a combined motion 207 to the right, where the combined motion may consist of at least one of the virtual object motion 203 and the viewpoint motion 205. The relative screen space motion may be considered as viewpoint motion, where the portion of object motion may be considered part of the viewpoint motion.

In particular embodiments, the computing device 108 may use a parallax motion as a pseudo depth cue to predict multi-frame reprojection. The parallax motion of an object in the XR content may be caused by the viewpoint motion of the user 102 wearing the display 114. In the absence of depth information, for multiple frame drops, the computing device 108 may assume that all motion is from static scene objects, at the possible expense of adding extra error to reprojection of dynamic scene objects. In general, nearby static objects provide contextual clues to the XR experience, and errors in projecting the nearby static objects may cause more discomfort than localized moving objects. Therefore, in rendering a XR environment, XR developers may have most of the scene contain static content with limited moving objects to improve comfort. Additionally, since dynamic objects may have both parallax motion and object motion, any nonlinear head motion may result in ill-posed errors for the relative screen space motion, and the static object assumption may not exacerbate those unrecoverable errors. The computing device 108 may render multiple dropped frames for the static objects with the user's head movement and may discard corrections to moving objects. The computing device 108 may account for object motions due to viewpoint change (parallax) in predicting multiple dropped frames. The computing device 108 may assume the moving object is static and render the moving object in the multiple dropped frames based on the parallax motion alone. The user of an XR application with moving objects may notice multiple frame drops when the dropped frames are rendered using PASW, the users may be able to move around the virtual world comfortably with PASW during a connection interruption.

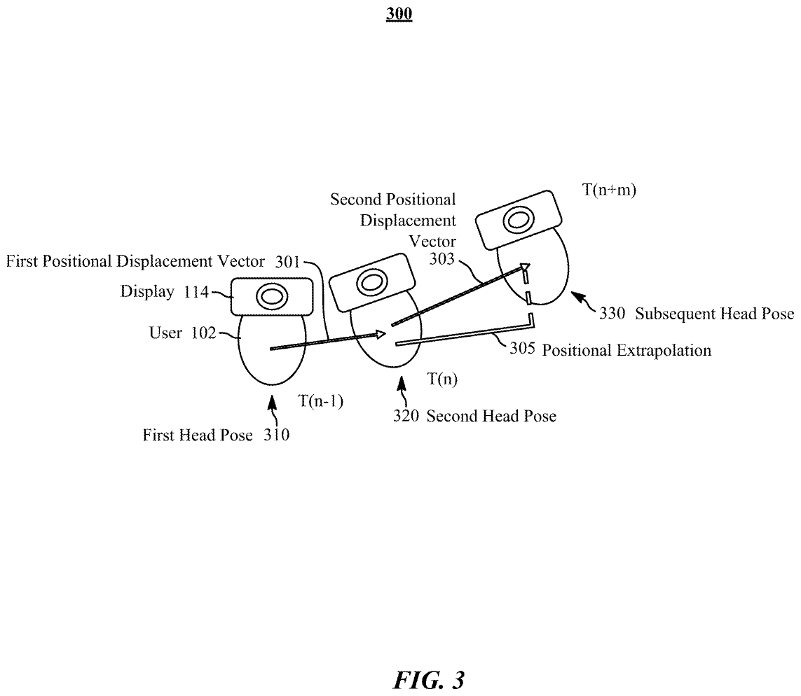

In particular embodiments, the computing device 108 may determine a positional extrapolation based on the user's translational motion. The computing device 108 may determine a projection of a head pose change of the user onto the position delta of the last two frames according to the user's translational motion. For a linear motion of the user's head, the position-based extrapolation corresponds to the time-based extrapolation as in ASW. For a nonlinear motion (e.g., acceleration) of the user's head, the positional extrapolation may indicate the positional displacement of the user's head along an original parallax axis generated by the last two rendered frames. FIG. 3 illustrates an example method for determining the positional extrapolation due to the user's translational motion. The computing device may determine a first head pose 310 of the user 102 wearing the display 114 at time T(n−1) and a second head pose 320 of the user 102 at time T(n). The time T(n−1) and T(n) may be associated with the last two consecutive image frames of a video stream rendered at a typical frame rate (e.g., 60 fps) without connection interruptions. The computing system may determine a first positional displacement vector 301 based on the first head pose 310 at time T(n−1) and the second head pose 320 at time T(n). At time T(n+m), where m≥2, the computing system 108 may determine a subsequent head pose 330. The computing device 108 may then determine a second positional displacement vector 303 based on the second head pose 320 and the subsequent head pose 330. At time T(n+m), the computing device 108 may predict a subsequent frame due to connection interruptions (e.g., Bluetooth disconnection). To extrapolate the subsequent frame and reduce the discomfort of the user 102, the computing system 108 may determine a positional extrapolation 305 to warp the last received frame at time T(n) to T(n+m) for a continuous and comfortable XR experience. The computing device 108 may generate the positional extrapolation 305 for the subsequent head pose 330 by projecting the second positional displacement vector 303 onto the first positional displacement vector 301.

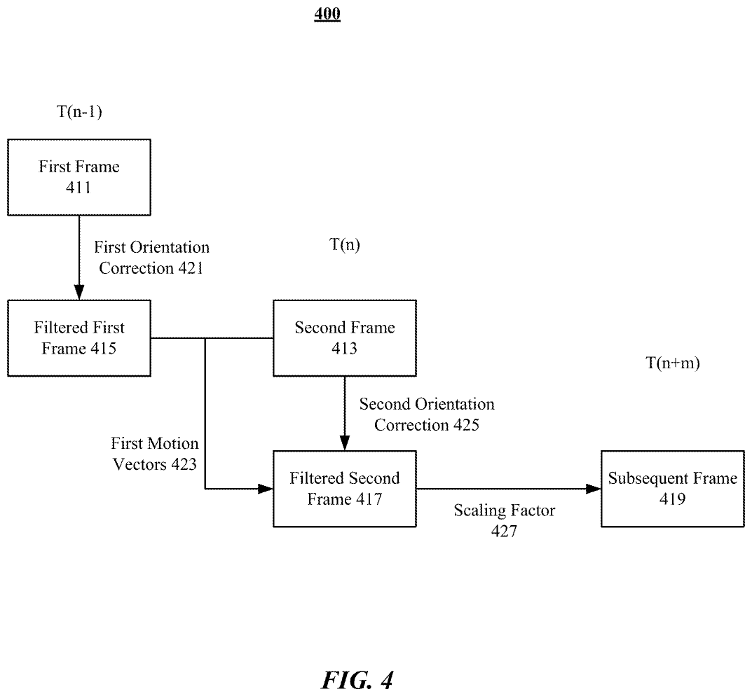

In particular embodiments, the computing device 108 may filter rotation motions of the user's head. FIG. 4 illustrates an example parallax asynchronous spacewarp rendering process. The computing device 108 may obtain a first frame 411 rendered for the first head pose 310 at time T(n−1) and a second frame 413 rendered for the second head pose 320 at time T(n). Additionally or alternatively, the computing device 108 may perform a first orientation correction 421 to warp the first frame 411 to a filtered first frame 415 such that the computing device 108 may account for only translation motions due to the head pose change in PASW. The filtered first frame 412 may have the second frame 413's orientation. The computing device may use ATW to perform the first orientation correction 421. The computing device may determine a first motion vectors 423 of pixels within the filtered first frame 415 based on the filtered first frame 415 and the second frame 413. Similarly, the computing device 108 may perform a second orientation correction 425 to reproject the second frame 413 to a filtered second frame 417 such that the filtered second frame 417 may have the subsequent frame 419's orientation based on the subsequent head pose 330. The computing device may use ATW to perform the second orientation correction 425. The computing device may determine a scaling factor 427 to scale the first motion vectors 423 based on the positional extrapolation 305. The computing device may then render the subsequent frame 419 at time T(n+m) based on the scaled motion vectors and the filtered second frame 417.

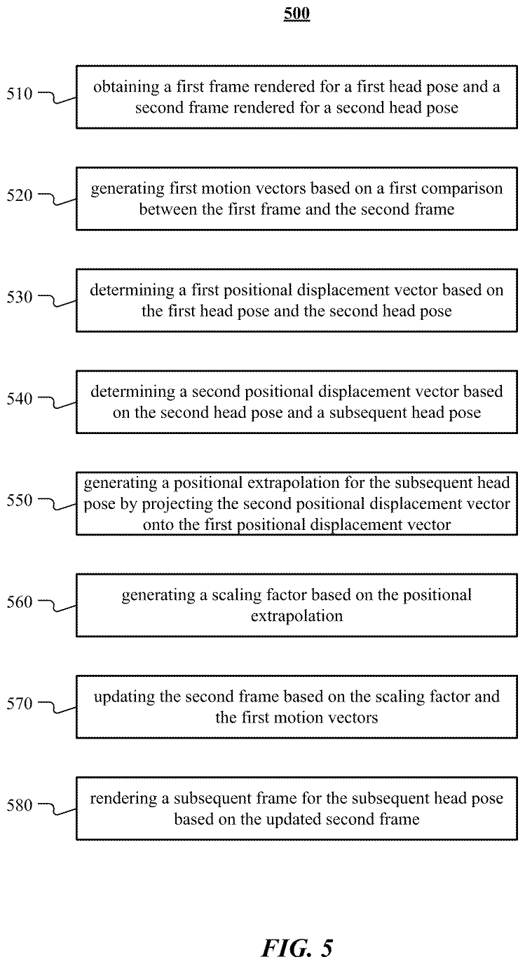

FIG. 5 illustrates an example method 500 for parallax asynchronous spacewarp for multiple frame extrapolation. The method may begin at step 510, where the computing device 108 may obtain a first frame rendered for a first head pose and a second frame rendered for a second head pose. At step 520, the computing device 108 may generate first motion vectors based on a first comparison between the first frame and the second frame. The first motion vectors may comprise a plurality of motion vectors for each pixel or pixel block (e.g., 8*8 pixel block) for the first frame and the second frame. At step 530, the computing device 108 may determine a first positional displacement vector based on the first head pose and the second head pose. At step 540, the computing device 108 may determine a second positional displacement vector based on the second head pose and a subsequent head pose. At step 550, the computing device 108 may generate a positional extrapolation for the subsequent head pose by projecting the second positional displacement vector onto the first positional displacement vector. At step 560, the computing device 108 may generate a scaling factor based on the positional extrapolation. The computing device may calculate the scaling factor by dividing the positional extrapolation by the first displacement vector. At step 570, the computing device 108 may update the second frame based on the scaling factor and the first motion vectors. Specifically, the computing device 108 may update the second frame based on a product of the scaling factor and the first motion vectors. At step 580, the computing device 108 may render a subsequent frame for the subsequent head pose based on the updated second frame. Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for parallax asynchronous spacewarp for multiple frame extrapolation including the particular steps of the method of FIG. 5, this disclosure contemplates any suitable method for parallax asynchronous spacewarp for multiple frame extrapolation including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

In particular embodiments, the first motion vectors derived from the first frame and the second frame may comprise an object motion component and a parallax motion component. The computing device 108 may project the 3D head motion between the two rendered frames in the real world into the 2D display space, and obtain a head motion direction. The computing device 108 may then decompose the first motion vectors into parallel and perpendicular components based on the head motion direction. The parallel component may contain both the object motion component and the parallax motion component. However, the perpendicular component may contain only the object motion component. The computing device 108 may apply different scaling factors to each parallel component and perpendicular component to obtain subsequent extrapolated frames consistent with different object motion assumptions (e.g., linear motion, nonlinear motion, etc.).

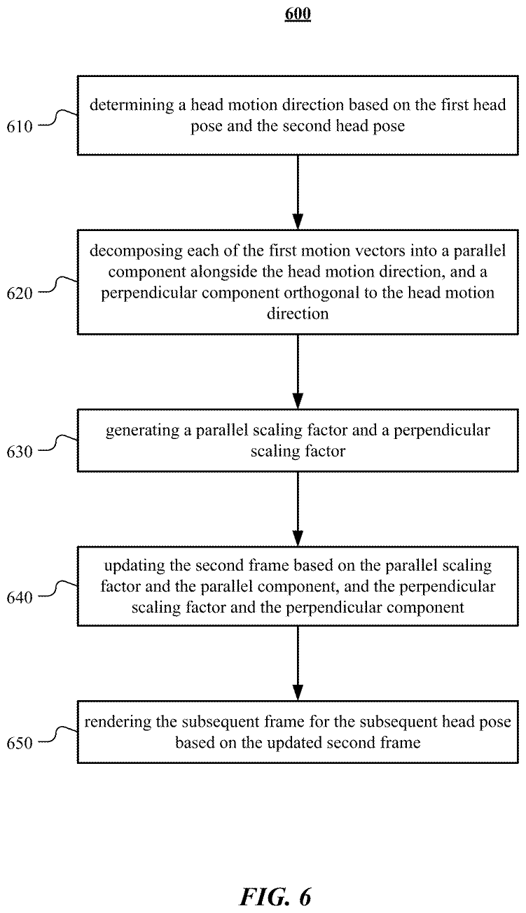

FIG. 6 illustrates an example method 600 for parallax asynchronous spacewarp for multiple frame extrapolation based on decomposed component scaling. The method may begin at step 610, where the computing device may determine a head motion direction based on the first head pose and the second head pose. At step 620, the computing device may decompose each of the first motion vectors into a parallel component alongside the head motion direction, and a perpendicular component orthogonal to the head motion direction. At step 630, the computing device may generate a parallel scaling factor and a perpendicular scaling factor. At step 640, the computing device may update the second frame based on the parallel scaling factor and the parallel component, and the perpendicular scaling factor and the perpendicular component. At step 650, the computing device may render the subsequent frame for the subsequent head pose based on the updated second frame. The parallel scaling factor may be a position-based scaler as in PASW. The computing device 108 may assume the object motion in the parallax direction to the head motion direction are due to parallax and generate the position-based scaler based on the head pose change. Additionally or alternatively, the parallel scaling factor may be a time-based scaler where the computing device 108 may assume that the head and/or the object in the scene may have linear motions and generate the parallel scaling factor based on elapsed time from the last frame generally normalized to the motion vectors representation. The perpendicular scaling factor may be zero to eliminate any head or object motion in the direction that is perpendicular to the head motion direction. Additionally or alternatively, the perpendicular scaling factor may be time-based. The computing device 108 may assume that the object in the scene may have linear motions and generate the parallel scaling factor based on elapsed time from the last frame since no there may exist no head motions in the perpendicular direction. For example, the user's head may moves to the right and an animation in the scene may include a ball dropping vertically to the ground. The computing device 108 may use a time-based scaling factor for a vertical component perpendicular to the head motion direction to the right to render a subsequent frame since the dropping ball does not have a component along the parallel direction of the head motion direction. Alternatively, the computing device 108 may scale the vertical component with zero to eliminate the object motion of the ball to reduce the user's discomfort when both head motion and object motion occur. In another example, the user's head may move to the right and an animation in the scene may include a ball having projectile motion. The computing device 108 may decompose the motion vectors associated with the ball into a parallel component and a perpendicular component. The parallel component is horizontal and parallel to the head motion direction to the right, and the perpendicular component is vertical and perpendicular to the head motion direction to the right. The computing device 108 may generate a parallel scaling factor based on the head pose change associated with the subsequent head pose to scale the parallel component. Specially, the computing device 108 may generate the positional extrapolation to determine the parallel scaling factor for the parallel component. The computing device 108 may assume a linear motion of the ball and/or the use's head in the vertical direction and generate a perpendicular scaling factor based on the elapsed time from the last rendered frame to scale the perpendicular component. The computer device 108 may then update the second frame rendered for a second head pose according to a first product of the parallel component and the parallel scaling factor, and a second product of the perpendicular component and the perpendicular scaling factor. The computing device 108 may render the subsequent frame for the subsequent head pose based on the updated second frame.

Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for parallax asynchronous spacewarp for multiple frame extrapolation based on decomposed component scaling including the particular steps of the method of FIG. 6, this disclosure contemplates any suitable method for parallax asynchronous spacewarp for multiple frame extrapolation based on decomposed component scaling including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

TABLE A is an example user study to show users' preferences with different rendering techniques, including ASW, ATW, and PASW, for an increasing number of dropped frames. The XR content used for this study consists of close static scenery from the user's viewpoint. Rendering dropped frames using ASW for one dropped frame and PASW for two to four dropped frames are compared with rendering the one to four dropped frames using ATW. The results show cumulative results correspond to 1 for a preference for PASW rendering, 0 for no preference, and −1 for a preference for ATW. As shown in TABLE A, the results indicate user preferences for PASW for higher frame drops over ATW.

TABLE A
Averaged Cumulative Results

| | | ATW | | | |
|---|---|---|---|---|---|
| | Dropped Frames | 1 | 2 | 3 | 4 |
| ASW | 1 | 50.00% | | | |
| PASW | 2 | 50.00% | 50.00% | | |
| | 3 | 16.67% | 50.00% | 66.67% | |
| | 4 | | −50.00% | −33.33% | 66.67% |

### Systems and Methods

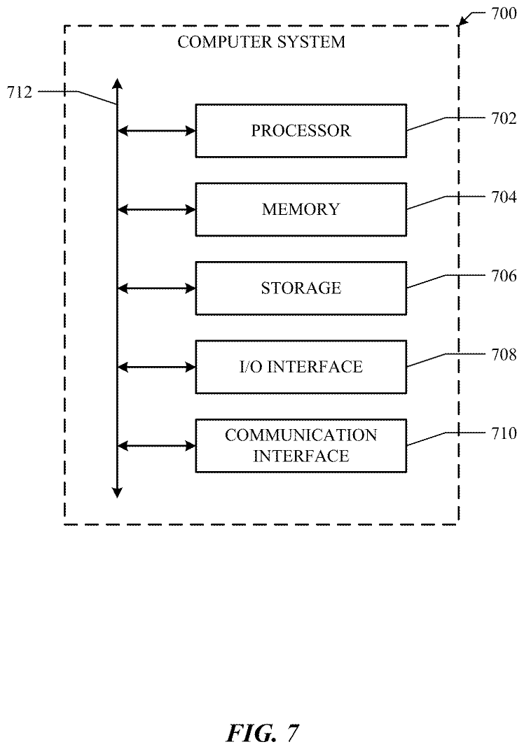

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A computer implemented method, comprising:
obtaining a first frame rendered for a first head pose and a second frame rendered for a second head pose;
generating first motion vectors based on a first comparison between the first frame and the second frame;
determining a first positional displacement vector based on the first head pose and the second head pose;
determining a second positional displacement vector based on the second head pose and a subsequent head pose;
generating a positional extrapolation for the subsequent head pose by projecting the second positional displacement vector onto the first positional displacement vector;
generating a scaling factor based on the positional extrapolation;
updating the second frame based on the scaling factor and the first motion vectors; and
rendering a subsequent frame for the subsequent head pose based on the updated second frame.

2. The method of claim 1, further comprising:
warping the first frame to have a first orientation of the second frame prior to generating the first motion vectors.

3. The method of claim 1, further comprising:
warping the second frame to have a second orientation of the subsequent frame.

4. The method of claim 1, further comprising:
determining a head motion direction based on the first head pose and the second head pose;
decomposing each of the first motion vectors into a parallel component alongside the head motion direction, and a perpendicular component orthogonal to the head motion direction;
generating a parallel scaling factor and a perpendicular scaling factor;
updating the second frame based on the parallel scaling factor and the parallel component, and the perpendicular scaling factor and the perpendicular component; and
rendering the subsequent frame for the subsequent head pose based on the updated second frame.

5. The method of claim 4, wherein the parallel scaling factor being position-based, or time-based.

6. The method of claim 4, wherein the perpendicular scaling factor being zero, or time-based.

7. The method of claim 1, wherein the subsequent image frame being rendered after at least two consecutive frames after the second frame.

8. The method of claim 1, wherein each of the first motion vectors comprises at least one of an object motion vector and a parallax motion vector.

9. One or more computer-readable non-transitory storage media embodying software that is operable when executed to:
obtain a first frame rendered for a first head pose and a second frame rendered for a second head pose;
generate first motion vectors based on a first comparison between the first frame and the second frame;
determine a first positional displacement vector based on the first head pose and the second head pose;
determine a second positional displacement vector based on the second head pose and a subsequent head pose;
generate a positional extrapolation for the subsequent head pose by projecting the second positional displacement vector onto the first positional displacement vector;
generate a scaling factor based on the positional extrapolation;
update the second frame based on the scaling factor and the first motion vectors; and
render a subsequent frame for the subsequent head pose based on the updated second frame.

10. The media of claim 9, wherein the software is further operable when executed to:
warp the first frame to have a first orientation of the second frame prior to generating the first motion vectors.

11. The media of claim 9, wherein the software is further operable when executed to:
warp the second frame to have a second orientation of the subsequent frame.

12. The media of claim 9, wherein the software is further operable when executed to:
determine a head motion direction based on the first head pose and the second head pose;
decompose each of the first motion vectors into a parallel component alongside the head motion direction, and a perpendicular component orthogonal to the head motion direction;
generate a parallel scaling factor and a perpendicular scaling factor;
update the second frame based on the parallel scaling factor and the parallel component, and the perpendicular scaling factor and the perpendicular component; and
render the subsequent frame for the subsequent head pose based on the updated second frame.

13. The media of claim 12, wherein the parallel scaling factor being position-based, or time-based.

14. The media of claim 12, wherein the perpendicular scaling factor being zero, or time-based.

15. The media of claim 9, wherein the subsequent image frame being rendered after at least two consecutive frames after the second frame.

16. The media of claim 9, wherein each of the first motion vectors comprises at least one of an object motion vector and a parallax motion vector.

17. A system comprising:
one or more processors; and
one or more computer-readable non-transitory storage media coupled to one or more of the processors and comprising instructions operable when executed by one or more of the processors to cause the system to:
obtain a first frame rendered for a first head pose and a second frame rendered for a second head pose;
generate first motion vectors based on a first comparison between the first frame and the second frame;
determine a first positional displacement vector based on the first head pose and the second head pose;
determine a second positional displacement vector based on the second head pose and a subsequent head pose;
generate a positional extrapolation for the subsequent head pose by projecting the second positional displacement vector onto the first positional displacement vector;
generate a scaling factor based on the positional extrapolation;
update the second frame based on the scaling factor and the first motion vectors; and
render a subsequent frame for the subsequent head pose based on the updated second frame.

18. The system of claim 17, wherein the processors are further operable when executing the instructions to:
warp the first frame to have a first orientation of the second frame prior to generating the first motion vectors.

19. The system of claim 17, wherein the processors are further operable when executing the instructions to:
warp the second frame to have a second orientation of the subsequent frame.

20. The system of claim 17, wherein the processors are further operable when executing the instructions to:
determine a head motion direction based on the first head pose and the second head pose;
decompose each of the first motion vectors into a parallel component alongside the head motion direction, and a perpendicular component orthogonal to the head motion direction;
generate a parallel scaling factor and a perpendicular scaling factor;
update the second frame based on the parallel scaling factor and the parallel component, and the perpendicular scaling factor and the perpendicular component; and
render the subsequent frame for the subsequent head pose based on the updated second frame.
